(19) United States
(12) Patent Application Publication
(10) Pub. No.: US 2012/0230489 A1
(43) Pub. Date: Sep. 13, 2012

(54) APPARATUS AND METHOD FOR SHORT RANGE COMMUNICATION IN MOBILE TERMINAL

(75) Inventor: Young Ho CHO, Seoul (KR)

(73) Assignee: SAMSUNG ELECTRONICS CO. LTD., Suwon-si (KR)

(21) Appl. No.: 13/415,153

(22) Filed: Mar. 8, 2012

(30) Foreign Application Priority Data
Mar. 11, 2011 (KR) 10-2011-0021909

(51) Int. Cl. H04K 1/00

(52) U.S. Cl. 380/270

(57) ABSTRACT

An apparatus and method for short range communication in a mobile terminal are provided. The apparatus includes a Near Field Communication (NFC) unit for sending and receiving data to and from the outside according to near field communication, a smart card having multiple contact points, and a security module, connected with one of the contact points of the smart card through a single wire protocol, for decrypting data from the NFC unit and sending the decrypted data to the smart card, and for encrypting data from the smart card and sending the encrypted data to the NFC unit. Hence, it is possible to provide an encryption and decryption function independently of the COS, establish a common encryption and decryption standard, and secure reliability of encryption and decryption.

### PRIORITY

This application claims the benefit under 35 U.S.C. §119(a) of a Korean patent application filed on Mar. 11, 2011 in the Korean Intellectual Property Office and assigned Serial No. 10-2011-0021909, the entire disclosure of which is hereby incorporated by reference.

### BACKGROUND OF THE INVENTION

1. Field of the Invention

The present invention relates to an apparatus and method for short range communication in a mobile terminal More particularly, the present invention relates to a Near Field Communication (NFC) apparatus having a security module and to a communication method using the same.

2. Description of the Related Art

Mobile terminals have become a necessity of modern life due to increased features, services and availability of mobile communication systems. In terms of functionality, mobile terminals have evolved into multimedia communication devices that can provide basic voice call services, data transmission services, and supplementary services.

In particular, a mobile terminal having a Near Field Communication (NFC) module may support NFC services. Data fed to the NFC module is forwarded to a smart card installed in the mobile terminal and the Chip Operating System (COS) of the smart card decrypts the data. However, because smart card manufacturers tend to use proprietary encryption and decryption schemes, it is difficult to enforce standard encryption and decryption schemes across a variety of mobile terminals and NFC modules, thus lowering credibility or reliability of encryption and decryption of the data.

### SUMMARY OF THE INVENTION

Aspects of the present invention are to address at least the above-mentioned problems and/or disadvantages and to provide at least the advantages described below. Accordingly, an aspect of the present invention is to provide an apparatus for short range communication in a mobile terminal that can establish a common encryption and decryption standard and secure reliability of encryption and decryption.

Another aspect of the present invention is to provide a short range communication method for the apparatus.

In accordance with an aspect of the present invention, an apparatus for short range communication in a mobile terminal is provided. The apparatus includes a Near Field Communication (NFC) unit for sending and receiving data to and from the outside according to near field communication, a smart card having multiple contact points, and a security module, connected with one of the contact points of the smart card through a single wire protocol, for decrypting data from the NFC unit and sending the decrypted data to the smart card, and for encrypting data from the smart card and sending the encrypted data to the NFC unit.

In accordance with another aspect of the present invention, a method for short range communication in a mobile terminal that includes an NFC unit, a smart card, and a security module connected with the NFC unit and smart card through a single wire protocol. The method includes determining, by the NFC unit, whether the input data is associated with the smart card upon detecting generation of input data, sending, by the NFC unit, the input data to the security module when the input data is associated with the smart card, decrypting, by the security module, the input data, sending, by the security module, the decrypted input data to the smart card, and processing, by a Chip Operating System (COS) of the smart card, the decrypted input data.

In accordance with another aspect of the present invention, a method for short range communication in a mobile terminal that includes an NFC unit, a smart card, a security module connected with the NFC unit and smart card, and a main controller connected with the NFC unit and smart card. The method includes activating, by the main controller, a smart card read/write function and sending a power supply command for an external smart card to the NFC unit, sending, by the NFC unit, a power supply signal to the external smart card, receiving, by the NFC unit, response data from the external smart card, sending, by the NFC unit, the received response data to the security module, decrypting, by the security module, the response data, sending, by the security module, the decrypted response data to the smart card, and processing, by a Chip Operating System (COS) of the smart card, the decrypted response data.

In a feature of the present invention, a separate encryption and decryption chip is designed and disposed along a line of a Single Wire Protocol (SWP) of the smart card without using an encryption and decryption means in the COS. Hence, it is possible to implement an encryption and decryption means independently of the COS, establish a common encryption and decryption standard, and secure reliability of encryption and decryption. Encryption and decryption is performed by an external hardware module separately from the COS of the smart card and hence delay of the COS operation may be reduced.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of a mobile terminal according to an exemplary embodiment of the present invention;

FIG. 2 illustrates interactions between a smart card, a Near Field Communication (NFC) unit and a control unit in the mobile terminal according to an exemplary embodiment of the present invention;

FIG. 3 illustrates the configuration of a security module in the control unit according to an exemplary embodiment of the present invention;

FIG. 4 is a sequence diagram depicting a method for short range communication in the mobile terminal according to another exemplary embodiment of the present invention;

FIG. 5 is a sequence diagram depicting a method for short range communication in the mobile terminal according to another exemplary embodiment of the present invention;

FIG. 6 depicts flows of data in the method of FIG. 5 according to an exemplary embodiment of the present invention;

FIG. 7 is a sequence diagram depicting a method for short range communication in the mobile terminal according to another exemplary embodiment of the present invention;

FIG. 8 depicts flows of data in the method of FIG. 7 according to an exemplary embodiment of the present invention;

FIG. 9 is a sequence diagram depicting a method for short range communication in the mobile terminal according to another exemplary embodiment of the present invention; and

FIG. 10 depicts flows of data in the method of FIG. 9 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The mobile terminal, according to exemplary embodiments of the present invention, is a terminal having a short range communication module, and may be any information and communication appliance or multimedia appliance such as a mobile communication terminal, a Portable Multimedia Player (PMP), a Personal Digital Assistant (PDA), a smart phone, an MP3 player or any other similar electronic device or appliance.

In the exemplary embodiments of the present invention, the short range communication module is preferably a Near Field Communication (NFC) module, and may also be a Bluetooth module, a Wi-Fi module, a ZigBee communication module, an Infrared communication module or any other suitable wireless communication module.

NFC modules employ contactless short range wireless communication that enables data transmission at low power based on Radio Frequency IDentification (RFID) technology operating at a band of 13.56 MHz. NFC has been standardized by the European Computer Manufacturers Association (ECMA) International. NFC may be used in various situations. For example, bringing two NFC-enabled terminals close to each other allows them to send and receive data such as phone numbers, music files and photographs. Bringing an NFC-enabled terminal close to a smart card allows the terminal to read and write data from and to the smart card.

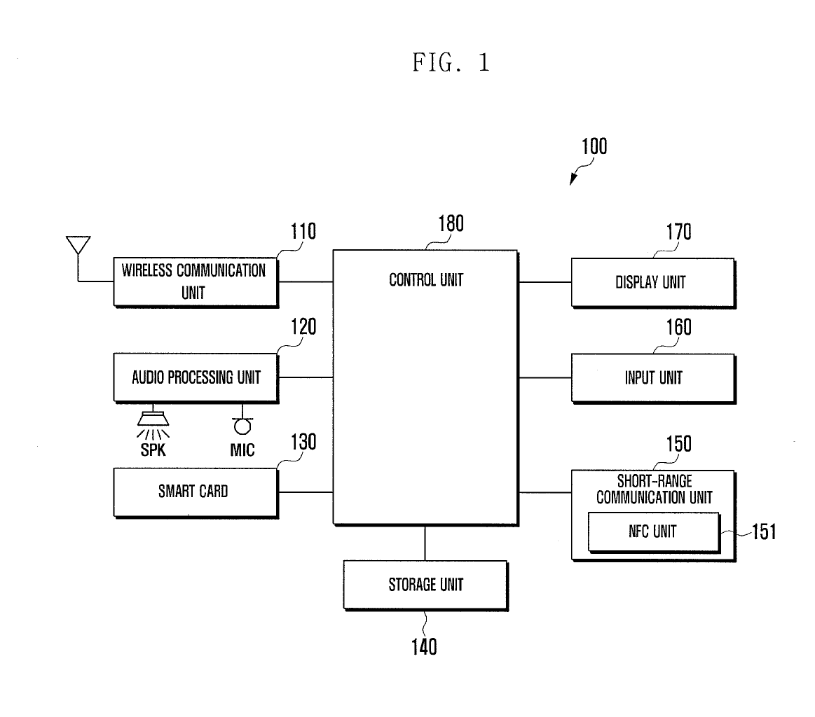

FIG. 1 is a block diagram of a mobile terminal 100 according to an exemplary embodiment of the present invention. The mobile terminal 100 includes a wireless communication unit 110, an audio processing unit 120, a smart card 130, a storage unit 140, a short-range communication unit 150, an input unit 160, a display unit 170, and a control unit 180.

Referring to FIG. 1, the wireless communication unit 110 sends and receives data for wireless communication of the mobile terminal 100. The wireless communication unit 110 may include a Radio Frequency (RF) transmitter for upconverting the frequency of a signal to be transmitted and amplifying the signal, and a RF receiver for low-noise amplifying a received signal and downconverting the frequency of the signal. The wireless communication unit 110 may receive data through a wireless channel and forward the received data to the control unit 180, and may also transmit data from the control unit 180 through the wireless channel.

The audio processing unit 120 may include a coder/decoder (codec). The codec may include a data codec for processing packet data, and an audio codec for processing an audio signal such as a voice signal. The audio processing unit 120 converts a digital audio signal into an analog audio signal through the audio codec and outputs the analog audio signal to a speaker SPK. The audio processing unit 120 also converts an analog audio signal input through a microphone MIC into a digital audio signal through the audio codec.

The smart card 130 is a card module that includes a chip to store specific information. In particular, the smart card 130 may store user identification information, such as a phone number, personal information, an email address, and other information related to credit cards, transportation cards, pre-loaded money for a specific service, Digital Rights Management (DRM) data, public key certificates, and other similar information.

The smart card 130 may include a Chip Operating System (COS), a Read Only Memory (ROM), a Random Access Memory (RAM) and an Electrically Erasable Programmable ROM (EEPROM). The COS controls the overall operation of the smart card 130. The ROM stores a system program for overall operation of the smart card 130, such as the COS; the RAM stores temporary data for internal operations on data; and the EEPROM may store authentication information for communication with an external card reader or external mobile terminal

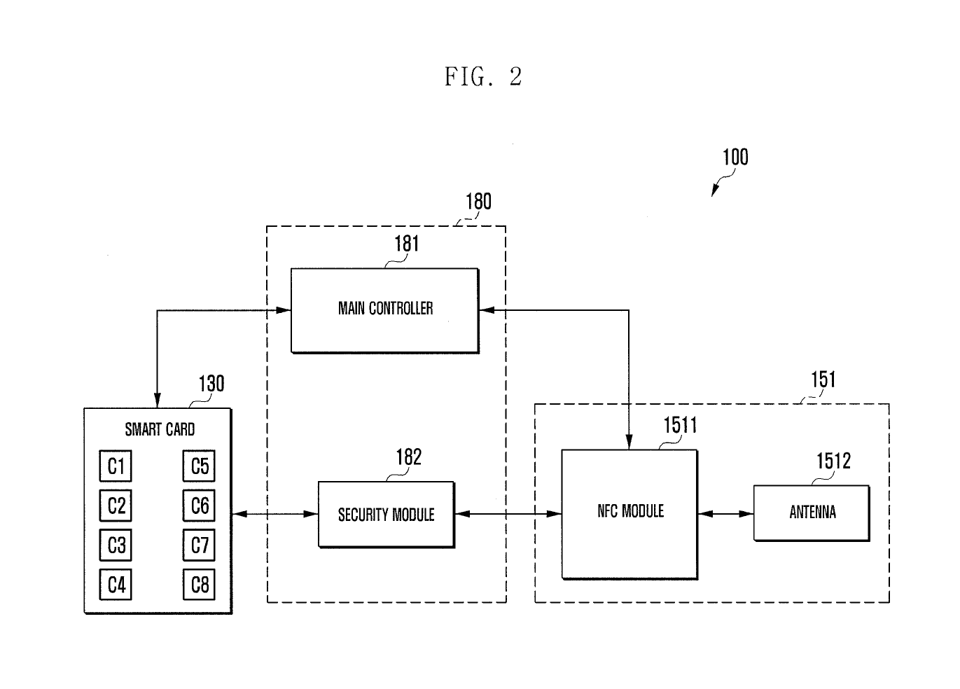

In particular, the smart card 130 is connected to an NFC unit 151 through a security module 182 (see FIG. 2) of the control unit 180. The smart card 130 includes multiple contact points (for example, eight contact points), one of which is connected to the security module 182 via a Single Wire Protocol (SWP). Here, the contact point connected to the security module 182 via the SWP may be a contact point C6 (see FIG. 2) from among eight contact points C1 to C8 (see FIG. 2). The smart card 130 may communicate with the NFC unit 151 through the security module 182 using a SigIn-SigOut Connection (S2C) interface.

The COS of the smart card 130 may extract authentication information, such as a user IDentification (ID), from the EEPROM and send the extracted authentication information to the NFC unit 151 through the security module 182. In response to an input signal from the control unit 180, the COS may provide the control unit 180 with user information for user identification and other information related to public key certificates, copyrights, and loaded money for a specific service.

The storage unit 140 stores programs and data necessary for operation of the mobile terminal 100, and may include a program region and a data region. The program region may store a control program for controlling the overall operation of the mobile terminal 100, an Operating System (OS) for booting the mobile terminal 100, an application program for playing back multimedia content, and application programs necessary for optional functions of the mobile terminal 100 related to photography, sound, and still and moving images or other similar content or data. The data region may store data generated in the course of using the mobile terminal 100, such as still images, moving images, phonebooks, audio data and other similar data.

The short-range communication unit 150 sends and receives signals for communication with an external device within a specified distance from the mobile terminal 100. In particular, the short-range communication unit 150 includes an NFC unit 151, and may further include at least one of a Wi-Fi module, a Bluetooth module, a ZigBee module and a Radio Frequency IDentification (RFID) module.

The NFC unit 151 performs near field communication with a smart card reader, an external smart card or an external mobile terminal. The NFC unit 151 sends data input from the outside, or in other words, data received by the NFC unit 151, to the control unit 180 and outputs or transmits data from the control unit 180 to the outside. The internal configuration of the NFC unit 151 is described in detail with reference to FIG. 2.

The input unit 160 generates a key signal according to a user manipulation for controlling the mobile terminal 100 or a user input performed on the input unit 160, and sends the key signal to the control unit 180. The input unit 160 may include a keypad having alphanumeric and direction keys arranged in a 3*4 or Qwerty layout, or a touch panel. The input unit 160 may further include a button key, a jog key and a wheel key. The input unit 160 generates an input signal for executing an application according to user input, and sends the input signal to the control unit 180. The executed application may be related to call handling, music playback, reproduction of still and moving images, photographs, Digital Multimedia Broadcasting (DMB) reception, or other similar operations, features and applications.

The display unit 170 may include Liquid Crystal Display (LCD) devices, Organic Light Emitting Diode (OLED) devices, Active Matrix Organic Light Emitting Diode (AMOLED) devices or other suitable display devices. The display unit 170 provides the user with various information such as menus, input data and function-setting data in a visible form. The display unit 170 may output a boot screen, an idle screen, a menu screen, a call handling screen, and other application screens.

The control unit 180 controls overall operations of the components of the mobile terminal 100. In particular, the control unit 180 is connected with the smart card 130 and the NFC unit 151, and handles data exchange between the smart card 130 and the NFC unit 151. The internal configuration of the control unit 180 is described in detail with reference to FIG. 2.

FIG. 2 illustrates interactions between the smart card 130, the NFC unit 151 and the control unit 180 in the mobile terminal 100 according to an exemplary embodiment of the present invention.

Referring to FIG. 2, which illustrates internal configurations of the NFC unit 151 and the control unit 180, the NFC unit 151 includes an NFC module 1511 and an antenna 1512; and the control unit 180 includes a main controller 181 and a security module 182.

The NFC module 1511 generates signals for near field communication and communicates with the main controller 181 and an external device, such as a card reader, a smart card, a mobile terminal or any other similar external device. Here, the NFC module 1511 communicates with the main controller 181 through an Inter-Integrated Circuit (I2C), a Universal Asynchronous Receiver/Transmitter (UART), a Universal Serial Bus (USB) interface, or other suitable interface, and communicates with an external device through contactless short-range communication using the antenna 1512.

The NFC module 1511 may generate an RF signal corresponding to a signal from the main controller 181 or the security module 182 and may transmit the RF signal through the antenna 1512 to an external device. The NFC module 1511 may generate a signal corresponding to an RF signal received through the antenna 1512 and forward the generated signal to the main controller 181 or the security module 182.

In an exemplary embodiment, when data is input through the antenna 1512 from an external device, the NFC module 1511 determines whether the input data is related to the smart card 130. When the input data is related to the smart card 130, the NFC module 1511 forwards the input data to the security module 182. When the input data is not related to the smart card 130, the NFC module 1511 forwards the input data to the main controller 181.

In another exemplary embodiment, when an Answer To Reset (ATR) request is received through the antenna 1512 from a card reader, the NFC module 1511 notifies the main controller 181 of reception of the ATR request. The NFC module 1511 may also notify the security module 182 of reception of the ATR request. The NFC module 1511 forwards data input from the card reader to the security module 182.

In another exemplary embodiment, when a command for transmitting a power supply signal to an external smart card is received from the main controller 181, the NFC module 1511 transmits a power supply signal through the antenna 1512 to the external smart card. Later, when response data is received through the antenna 1512 from the external smart card, the NFC module 1511 forwards the response data to the security module 182. When encrypted data is input from the security module 182, the NFC module 1511 sends the encrypted data through the antenna 1512 to an external device.

The main controller 181 controls the overall operation of the mobile terminal 100. The main controller 181 is connected to the smart card 130 and the NFC module 1511 and outputs command signals or data to the smart card 130 and the NFC module 1511.

The main controller 181 may communicate data to and from the smart card 130 according to the International Organization for Standardization (ISO) 7816 standard or by using the USB interface, and may communicate data to and from the NFC module 1511 through the I2C, UART or USB interface.

When data is input from the NFC module 1511, the main controller 181 may decrypt the input data using a security module and process the decrypted input data. Here, the input data may be decrypted using the security module 182 or another security module. The main controller 181 may store the decrypted input data in the storage unit 140 or output the same to the audio processing unit 120 or to the display unit 170.

When a notification for ATR request reception is received from the NFC module 1511, the main controller 181 may switch the operating mode of the mobile terminal 100 from an NFC mode to a card emulation mode. When a smart card read/write command is input from the input unit 160, the main controller 181 may send a power supply command for an external smart card to the NFC module 1511. When a data transport command is input from the input unit 160, the main controller 181 may forward the data transport command to the smart card 130.

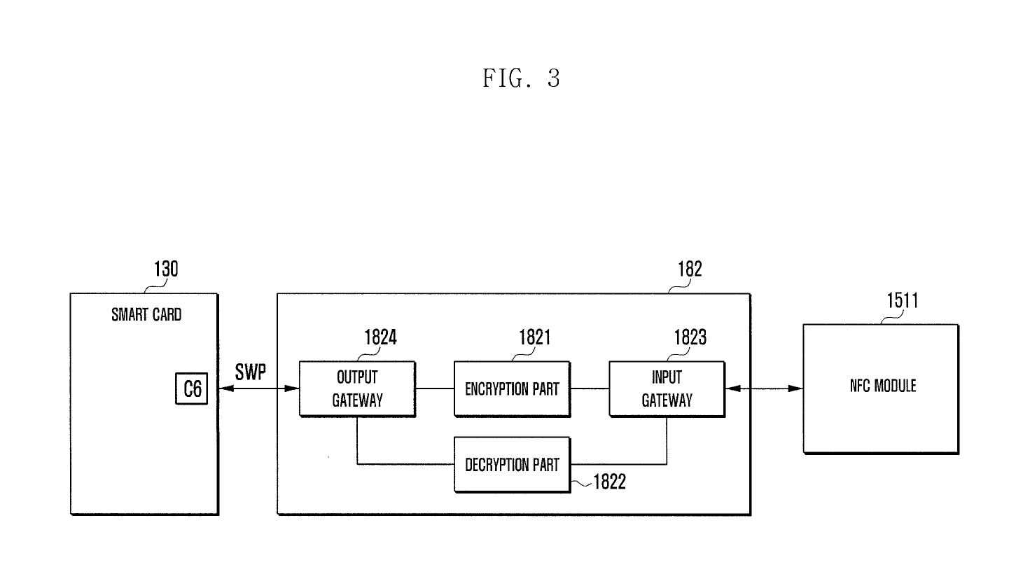

The security module 182 encrypts and decrypts data exchanged between the smart card 130 and the NFC module 1511. The security module 182 connects the smart card 130 with the NFC module 1511 through the Single Wire Protocol (SWP). In particular, the security module 182 is connected through the SWP to the contact point C6, from among the eight contact points C1 to C8, of the smart card 130. The security module 182 acts as a mediator for communication between the smart card 130 and the NFC module 1511. The security module 182 decrypts data from the NFC module 1511 and forwards the decrypted data to the smart card 130. The security module 182 also encrypts data from the smart card 130 and forwards the encrypted data to the NFC module 1511. The internal configuration of the security module 182 is described further in connection with FIG. 3.

In an exemplary embodiment, a protocol matcher may be included between the NFC module 1511 and the security module 182 or between the security module 182 and the smart card 130. The protocol matcher performs protocol conversion between the NFC module 1511 and the security module 182 and between the security module 182 and the smart card 130. For example, when the NFC module 1511 communicates using the I2C interface and the smart card 130 communicates using the ISO 7816 standard, the protocol matcher performs conversion between I2C interface and ISO 7816 standard.

FIG. 3 illustrates the configuration of the security module 182 in the control unit 180 according to an exemplary embodiment of the present invention.

Referring to FIG. 3, which depicts interactions between the security module 182, the smart card 130 and the NFC module 1511, the security module 182 includes an encryption part 1821, a decryption part 1822, an input gateway 1823 and an output gateway 1824.

The encryption part 1821 encrypts data from the smart card 130, and the decryption part 1822 decrypts data from the NFC module 1511. Encryption and decryption may be performed using a stream cipher algorithm that encrypts one plaintext bit or one plaintext byte at a time or using a block cipher algorithm that encrypts one plaintext fixed-size block at a time. However, the present invention is not limited thereto, and any suitable cryptographic algorithm may be used in the present invention.

The input gateway 1823 is connected to the NFC module 1511, the encryption part 1821 and the decryption part 1822. The input gateway 1823 forwards data from the NFC module 1511 to the decryption part 1822 and forwards data from the encryption part 1821 to the NFC module 1511. The output gateway 1824 is connected to the smart card 130, the encryption part 1821 and the decryption part 1822. The output gateway 1824 forwards data from the smart card 130 to the encryption part 1821 and forwards data from the decryption part 1822 to the smart card 130. The smart card 130 and the output gateway 1824 are connected with a single line supporting bidirectional communication. Additionally, the input gateway 1823 and the NFC module 1511 are connected with a single line supporting bidirectional communication.

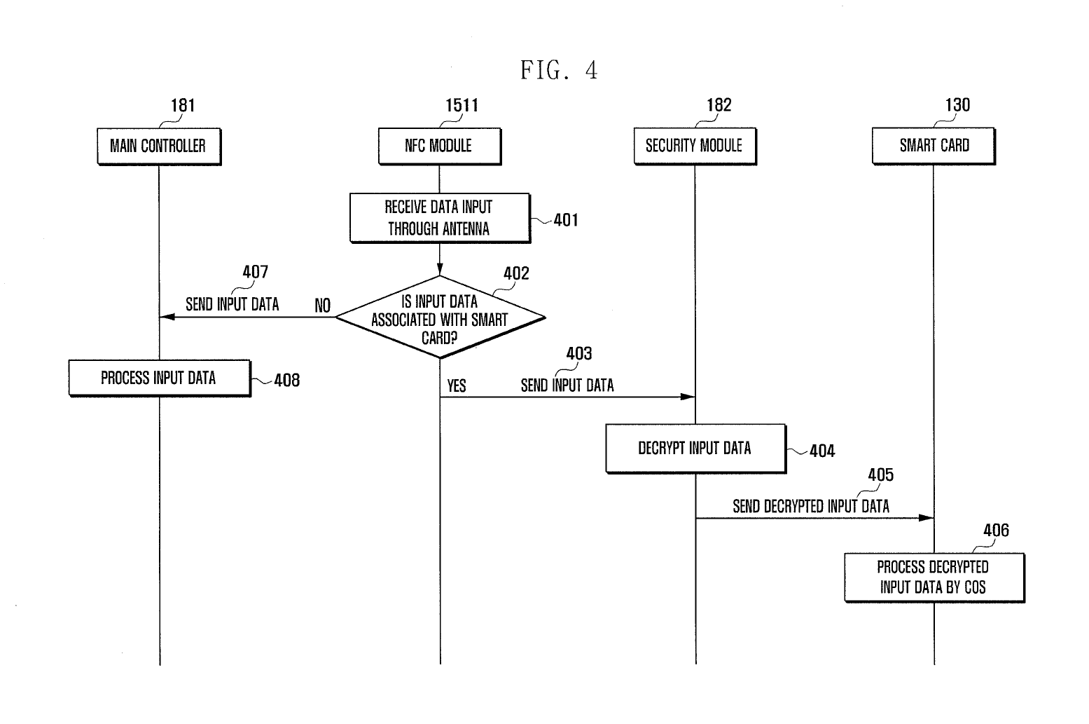

FIG. 4 is a sequence diagram depicting a method for short range communication in the mobile terminal 100 according to another exemplary embodiment of the present invention.

Referring to FIG. 4, the method is described with a focus on the NFC module 1511, the security module 182, the smart card 130 and the main controller 181.

The NFC module 1511 receives data input through the antenna 1512 in step 401. For example, when the user brings the mobile terminal 100 close to an external device such as a card reader or other mobile terminal, the NFC module 1511 may receive data from the external device through the antenna 1512.

The NFC module 1511 determines whether the input data from the external device is associated with the smart card 130 in step 402. The smart card 130 may store user identification information, credit card information, transportation card information, loaded money information corresponding to a specific service, DRM information, and public key certificate information. The NFC module 1511 may determine whether to communicate with the smart card 130 by checking whether the input data is credit card information, transportation card information or the like. At step 402, the NFC module 1511 may determine whether to communicate with the main controller 181. That is, the NFC module 1511 may determine whether the input data is a photograph file or music file, or other similar files or data, having executable commands requiring processing of the main controller 181.

When the input data is associated with the smart card 130 or is data not requiring processing by the main controller 181, the NFC module 1511 forwards the input data to the security module 182 in step 403. The security module 182 decrypts the input data in step 404. In the security module 182, the input gateway 1823 receives the input data and forwards the same to the decryption part 1822 in order to decrypt the input data. After decryption, the security module 182 forwards the decrypted input data to the smart card 130 in step 405. Particularly, at step 405, the decryption part 1822 outputs the decrypted input data to the output gateway 1824, and the output gateway 1824 forwards the decrypted input data to the smart card 130.

Upon reception of the decrypted input data, the COS of the smart card 130 processes the decrypted input data in step 406. The COS may store the input data in the internal storage, such as the RAM or the EEPROM. When the input data is inquiry data, the COS may extract requested data from the internal storage and output the requested data to the security module 182.

When the input data is not associated with the smart card 130 or is data requiring processing of the main controller 181, the NFC module 1511 forwards the input data to the main controller 181 in step 407. Upon reception of the input data, the main controller 181 processes the input data in step 408. The main controller 181 decrypts the input data, and may store the decrypted input data or output the decrypted input data to the audio processing unit 120 or display unit 170. The main controller 181 may decrypt the input data using the security module 182 or any other suitable security means.

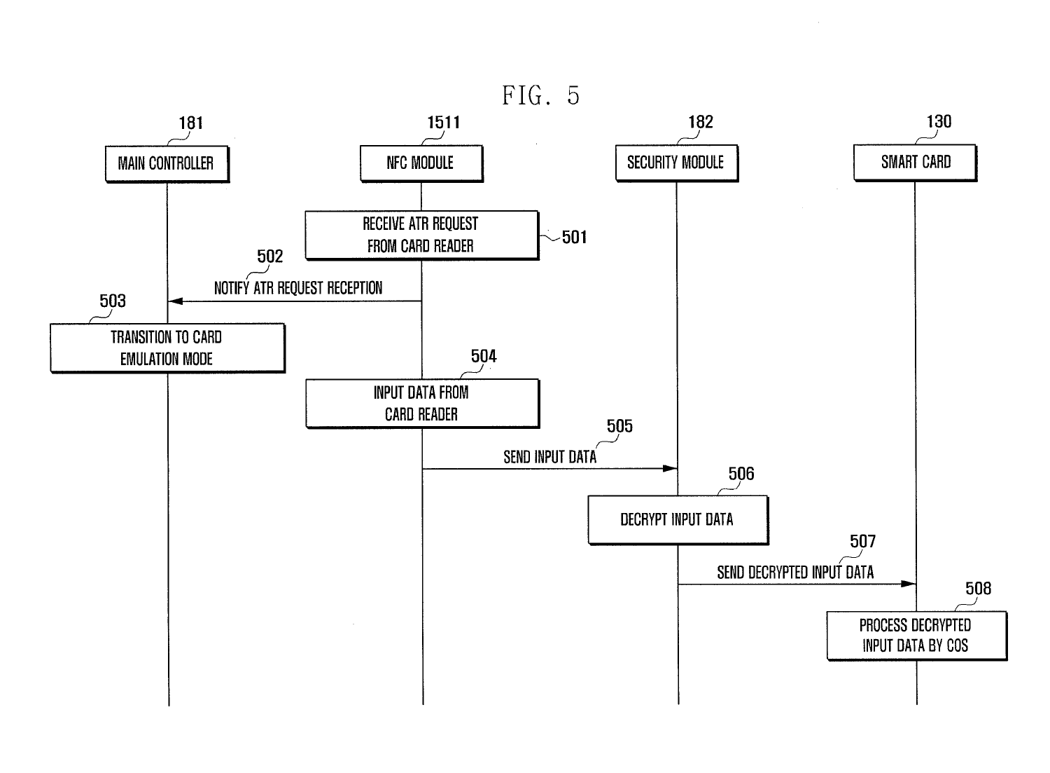

FIG. 5 is a sequence diagram depicting a method for short range communication in the mobile terminal 100 according to another exemplary embodiment of the present invention.

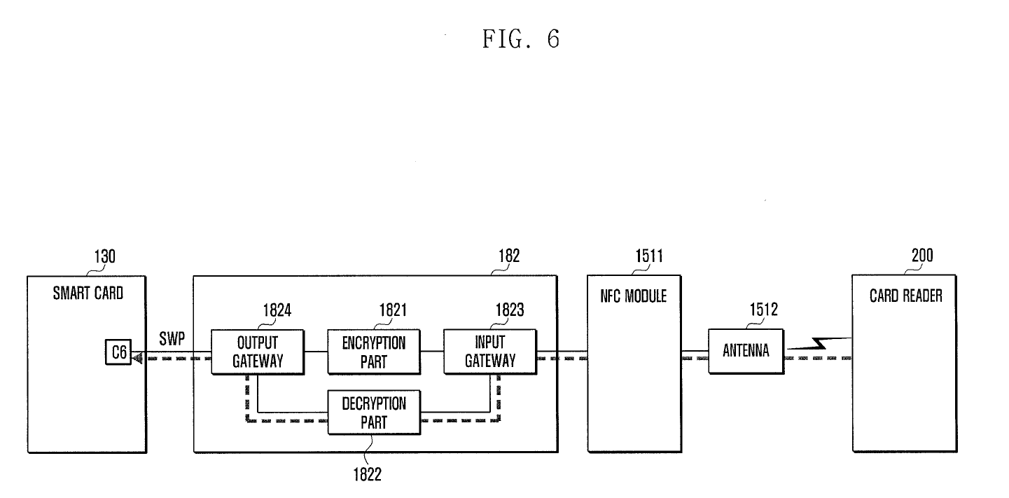

FIG. 6 depicts flows of data in the method of FIG. 5 according to an exemplary embodiment of the present invention.

Referring to FIGS. 5 and 6, the mobile terminal 100 performs near field communication with a card reader 200. The NFC module 1511 receives a request for an ATR from the card reader 200 in step 501. The ATR is a reset response signal sent by the smart card 130 to the card reader 200. When the card reader 200 makes an ATR request to the smart card 130, the smart card 130 sends a reset response signal that includes information on a card type, a model and a manufacturer to the card reader 200.

The NFC module 1511 sends a notification for an ATR request reception to the main controller 181 in step 502. When the notification for the ATR request reception is received, the main controller 181 switches an operating mode of the mobile terminal 100 from the NFC mode to the card emulation mode in step 503. In the card emulation mode, the mobile terminal 100 transmits information stored in the smart card 130 to the card reader 200.

With notification of the ATR request reception, the NFC may forward the received ATR request to the smart card 130. Here, the NFC module 1511 sends the ATR request to the security module 182, and the security module 182 forwards the ATR request to the smart card 130, wherein the security module 182 decrypts the ATR request and forwards the decrypted ATR request to the smart card 130. In return, the smart card 130 sends a reset response signal including the information on the card type, the model and the manufacturer to the security module 182, and the security module 182 forwards the reset response signal to the NFC module 1511. The security module 182 may encrypt the reset response signal and forward the encrypted reset response signal to the NFC module 1511. The NFC module 1511 transmits the reset response signal to the card reader 200 through the antenna 1512.

The NFC module 1511 receives data input from the card reader 200 in step 504. The NFC module 1511 forwards the input data to the security module 182 in step 505, and the security module 182 decrypts the input data in step 506. More specifically, in the security module 182, the input gateway 1823 receives the input data and forwards the input data to the decryption part 1822 in order for the input data to be decrypted. After decryption, the security module 182 forwards the decrypted input data to the smart card 130 in step 507. The COS of the smart card 130 processes the decrypted input data in step 508. The COS may store the input data in the internal storage such as a RAM or EEPROM. When the input data is inquiry data, the COS may extract requested data from the internal storage and output the extracted data to the security module 182.

Referring to FIG. 6, data generated by the card reader 200 is transmitted through the antenna 1512 to the NFC module 1511 and forwarded by the NFC module 1511 to the input gateway 1823. The data is forwarded by the input gateway 1823 to the decryption part 1822 in order to decrypt the data. The decrypted data is forwarded by the decryption part 1822 to the output gateway 1824, and the output gateway 1824 sends the decrypted data to the smart card 130 using the SWP. Hence, the COS of the smart card 130 may directly utilize the received data without a separate decryption process. In existing smart card technology, the COS has to execute commands from the main controller together with decryption operations, causing heavy system load. According to the exemplary embodiments of the present invention, because the COS of the smart card 130 may directly utilize received data without a separate decryption process, it is possible to reduce a system load and enhance efficiency in resource management due to the division of work and processing.

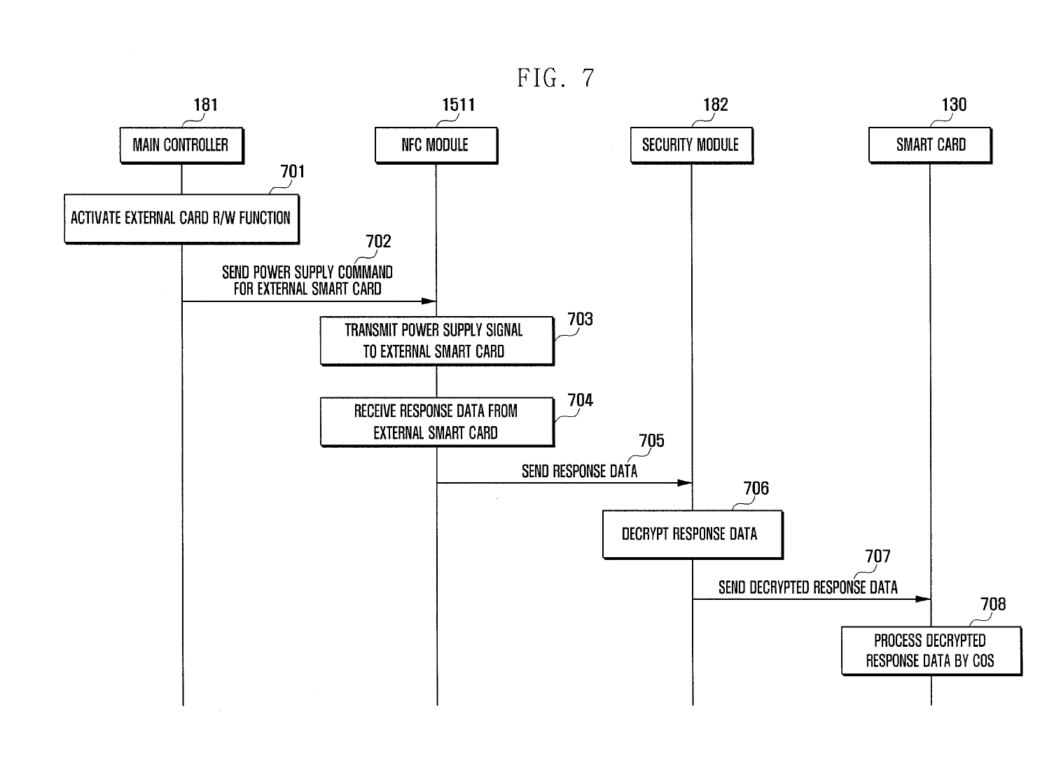

FIG. 7 is a sequence diagram depicting a method for short range communication in the mobile terminal 100 according to another exemplary embodiment of the present invention.

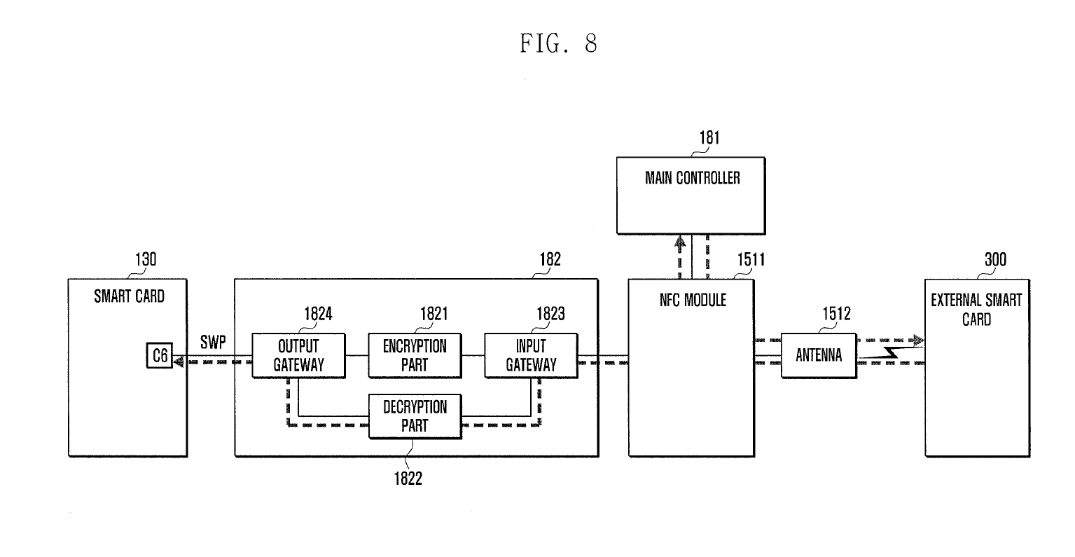

FIG. 8 depicts flows of data in the method of FIG. 7 according to an exemplary embodiment of the present invention.

Referring to FIGS. 7 and 8, the mobile terminal 100 performs card read/write operations. In FIG. 7, the mobile terminal 100 is assumed to be placed close to an external smart card so that the NFC module 1511 recognizes the external smart card.

Referring to FIG. 7, the main controller 181 activates an external card read/write function in step 701. The user may activate an external card read/write function by selecting a corresponding menu item of the mobile terminal 100 in order to generate a user command on the input unit 160. In response to the user command from the input unit 160, the main controller 181 activates the external card read/write function. After activation of the external card read/write function, the main controller 181 sends a power supply command for the external smart card to the NFC module 1511 in step 702. Upon reception of the power supply command from the main controller 181, the NFC module 1511 sends a power supply signal to the external smart card through the antenna 1512 in step 703.

The NFC module 1511 receives response data from the external smart card in step 704. Upon reception of the power supply signal from the NFC module 1511, the external smart card sends response data, including information on the card type, the model and the manufacturer and information on internally stored data to the NFC module 1511. Upon reception of the response data in step 704, the NFC module 1511 forwards the response data to the security module 182 in step 705. The security module 182 decrypts the response data in step 706. More specifically, in the security module 182, the input gateway 1823 receives the response data and forwards the response data to the decryption part 1822 in order for the response data to be decrypted. After decryption, the security module 182 forwards the decrypted response data to the smart card 130 in step 707. The COS of the smart card 130 processes the decrypted response data in step 708. The COS may store the input data in the internal storage, such as the RAM or the EEPROM. When the input data is inquiry data, the COS may extract requested data from the internal storage and output the extracted data to the security module 182.

In an exemplary embodiment, when the NFC module 1511 receives response data from the external smart card at step 704, the NFC module 1511 may determine whether the response data is associated with the internal smart card 130. When the response data is associated with the smart card 130, the NFC module 1511 may forward the response data to the security module 182, as shown in step 705. However, when the response data is not associated with the smart card 130, the NFC module 1511 may forward the response data to the main controller 181.

After step 704, the NFC module 1511 may determine whether the response data requires communication with the main controller 181. When the response data requires communication with the main controller 181, the NFC module 1511 may forward the response data to the main controller 181. When the response data does not require communication with the main controller 181, the NFC module 1511 may forward the response data to the security module 182.

Referring to FIG. 8, the main controller 181 sends a power supply command for an external smart card 300 to the NFC module 1511, and the NFC module 1511 sends a power supply signal to the external smart card 300 through the antenna 1512. The NFC module 1511 receives response data from the external smart card 300 through the antenna 1512. When the response data is associated with the smart card 130 or does not require communication with the main controller 181, the NFC module 1511 forwards the response data to the security module 182. When the response data is not associated with the smart card 130 or requires communication with the main controller 181, the NFC module 1511 forwards the response data to the main controller 181. In the security module 182, the input gateway 1823 receives the response data and forwards the response data to the decryption part 1822 in order to decrypt the response data. The decryption part 1822 forwards the decrypted data to the output gateway 1824, and the output gateway 1824 sends the decrypted data to the smart card 130 through the SWP.

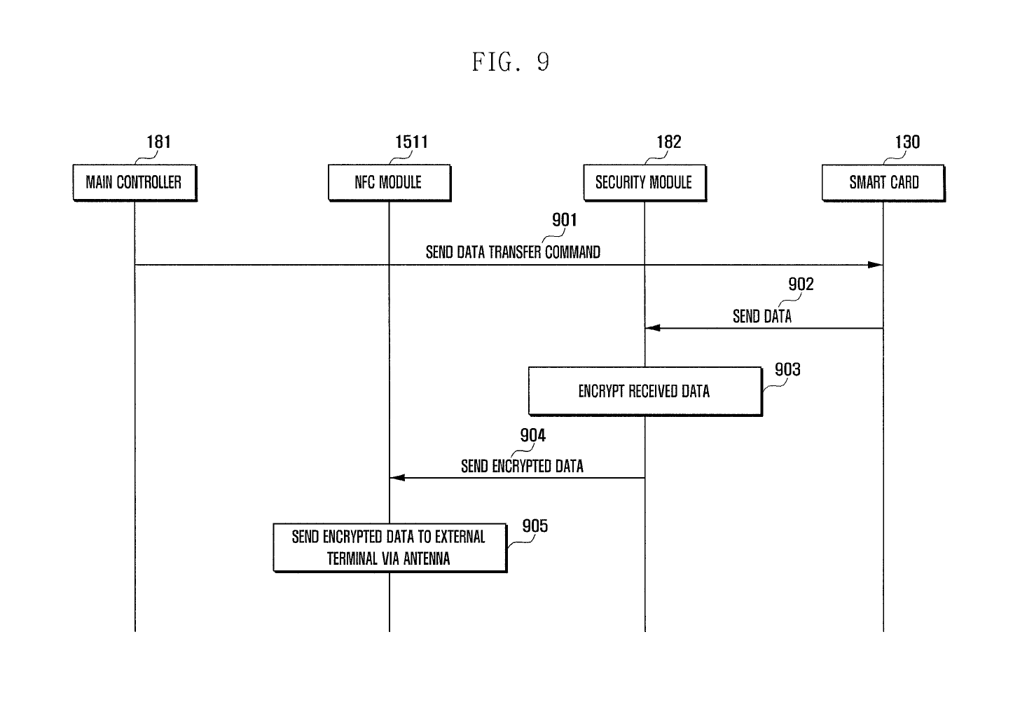

FIG. 9 is a sequence diagram depicting a method for short range communication in the mobile terminal 100 according to another exemplary embodiment of the present invention.

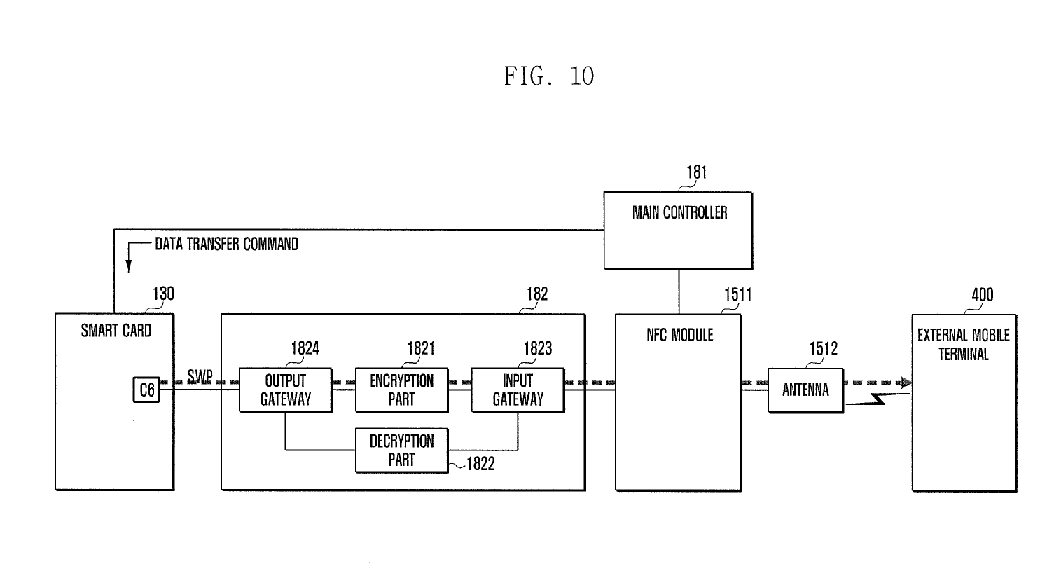

FIG. 10 depicts flows of data in the method of FIG. 9 according to an exemplary embodiment of the present invention.

Referring to FIGS. 9 and 10, the mobile terminal 100 exchanges data with an external mobile terminal In FIG. 9, the mobile terminal 100 is assumed to be placed close to an external mobile terminal 400 (see FIG. 10) so that the NFC module 1511 recognizes the external mobile terminal 400.

Referring to FIG. 9, the main controller 181 sends a data transfer command to the smart card 130 in step 901. The user may activate an NFC data transfer function by selecting a corresponding menu item of the mobile terminal 100 so as to be able to select at least one data item stored in the smart card 130 through the input unit 160 and then, by entering a command for sending the selected data item to the external mobile terminal 400. When the data transfer command signal is received from the input unit 160, the main controller 181 sends a data transfer command including identification information of the selected data item to the smart card 130. Here, the data transfer command may be sent to the smart card 130 according to the ISO 7816 standard or by using the USB interface.

Upon reception of the data transfer command from the main controller 181, the smart card 130 extracts data to be sent from the internal storage and sends the extracted data to the security module 182 in step 902. The security module 182 encrypts the received data in step 903. More particularly, in the security module 182, the output gateway 1824 receives the data and forwards the received data to the encryption part 1821 in order to encrypt the data.

After encryption, the security module 182 sends the encrypted data to the NFC module 1511 in step 904. In further detail, in the security module 182, the encryption part 1821 forwards the encrypted data to the input gateway 1823, and the input gateway 1823 sends the encrypted data to the NFC module 1511. Thereafter, the NFC module 1511 sends the encrypted data through the antenna 1512 to the external mobile terminal 400 in step 905.

Referring to FIG. 10, the main controller 181 sends a data transfer command to the smart card 130. The smart card 130 extracts data indicated by the command and sends the extracted data to the output gateway 1824 of the security module 182. The output gateway 1824 forwards the data to the encryption part 1821 in order to encrypt the data. The encryption part 1821 forwards the encrypted data to the input gateway 1823, and the input gateway 1823 sends the encrypted data to the NFC module 1511. The NFC module 1511 sends the encrypted data through the antenna 1512 to the external mobile terminal 400. In the process illustrated in FIG. 10, the smart card 130 directly sends extracted data to the outside without a separate encryption process. In existing smart cart technology, the COS has to execute commands from the main controller together with encryption operations, causing heavy system load. In the exemplary embodiments of the present invention, because a separate security module is included, COS processing load of the smart card 130 can be reduced.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for short range communication in a mobile terminal, the apparatus comprising:
a Near Field Communication (NFC) unit for sending and receiving data to and from the outside according to near field communication;
a smart card having multiple contact points; and
a security module, connected with one of the contact points of the smart card through a single wire protocol, for decrypting data from the NFC unit and sending the decrypted data to the smart card, and for encrypting data from the smart card and sending the encrypted data to the NFC unit.

2. The apparatus of claim 1, further comprising a main controller connected with the smart card and the NFC unit to communicate data to and from the smart card and the NFC unit.

3. The apparatus of claim 2, wherein the main controller communicates with the smart card according to an International Organization for Standards (ISO) 7816 standard or by using a Universal Serial Bus (USB) interface.

4. The apparatus of claim 2, wherein the main controller communicates with the NFC unit according to an Inter-Integrated Circuit (I2C), Universal Asynchronous Receiver/Transmitter (UART) or Universal Serial Bus (USB) interface.

5. The apparatus of claim 1, wherein the security module comprises:
an encryption part for encrypting data;
a decryption part for decrypting data;
an input gateway for receiving data; and
an output gateway for transmitting data,
wherein the input gateway is connected with the NFC unit through the single wire protocol and the output gateway is connected with one contact point of the smart card through the single wire protocol.

6. The apparatus of claim 5, wherein each of the input gateway and the output gateway is connected with the encryption part and the decryption part.

7. The apparatus of claim 6, wherein the input gateway forwards data from the NFC unit to the decryption part and sends data from the encryption part to the NFC unit.

8. The apparatus of claim 6, wherein the output gateway forwards data from the smart card to the encryption part and sends data from the encryption part to the smart card.

9. The apparatus of claim 2, wherein the security module is physically separate from the main controller.

10. A method for short range communication in a mobile terminal that includes a Near Field Communication (NFC) unit, a smart card, and a security module connected with the NFC unit and smart card through a single wire protocol, the method comprising:
determining, by the NFC unit, whether the input data is associated with the smart card, upon detecting generation of input data;
sending, by the NFC unit, the input data to the security module when the input data is associated with the smart card;
decrypting, by the security module, the input data;
sending, by the security module, the decrypted input data to the smart card; and
processing, by a Chip Operating System (COS) of the smart card, the decrypted input data.

11. The method of claim 10, wherein the mobile terminal includes a main controller connected with the smart card and the NFC unit, and
wherein the method of claim 10 further comprises:
sending, by the NFC unit, the input data to the main controller when the input data is not associated with the smart card; and
processing, by the main controller, the input data.

12. The method of claim 10, wherein the mobile terminal further comprises a main controller connected with the smart card and the NFC unit, and
wherein the method of claim 10 further comprises:
sending, by the NFC unit, a notification of ATR request reception to the main controller when an Answer To Reset (ATR) request is received from a card reader; and
performing, by the main controller, mode transition from NFC mode to card emulation mode.

13. A method for short range communication in a mobile terminal that includes a Near Field Communication (NFC) unit, a smart card, a security module connected with the NFC unit and smart card, and a main controller connected with the NFC unit and smart card, the method comprising:
activating, by the main controller, a smart card read/write function and sending a power supply command for an external smart card to the NFC unit;
sending, by the NFC unit, a power supply signal to the external smart card;
receiving, by the NFC unit, response data from the external smart card;
sending, by the NFC unit, the received response data to the security module;
decrypting, by the security module, the response data;
sending, by the security module, the decrypted response data to the smart card; and
processing, by a Chip Operating System (COS) of the smart card, the decrypted response data.

14. The method of claim 13, further comprising:
determining, by the NFC unit, whether the received response data is associated with the smart card in the mobile terminal; and
sending, by the NFC unit, the response data to the main controller when the response data is not associated with the smart card in the mobile terminal

15. A security module of Mobile Terminal including a Near Field Communication (NFC) unit for sending and receiving data for near field communication, and a smart card having multiple contact points, the security module comprising:
an input gateway for receiving data from the NFC unit;
an output gateway for transmitting data to the smart card;
an encryption part for encrypting the data transmitted to the smart card; and
a decryption part for decrypting the data received from the NFC unit,
wherein the input gateway is connected with the NFC unit through the single wire protocol and the output gateway is connected with one contact point of the smart card through the single wire protocol.

16. The security module of claim 15, wherein the input gateway and the output gateway are connected to both the encryption part and the decryption part.
